(19) United States
(12) Patent Application Publication
(10) Pub. No.: US 2026/0308026 A1
(43) Pub. Date: Oct. 8, 2026

(54) Treatment tank Partition System and Methods of Use

(71) Applicant: Geomatrix Systems, LLC, Old Saybrook, CT (US)

(72) Inventors: David A. Potts, Lyme, CT (US); David Jewett, Old Lyme, CT (US); Daniel Borkowski, Meriden, CT (US)

(21) Appl. No.: 19/636,028

(22) Filed: Apr. 1, 2026

Related U.S. Application Data
(60) Provisional application No. 63/782,375, filed on Apr. 2, 2025.

(51) Int. Cl. C02F 1/68

(52) U.S. Cl. CPC C02F 1/68; C02F 2201/004

(57) ABSTRACT

Systems, processes, apparatus, and articles of manufacture comprising, configured, designed, manufactured, transported, installed and/or operated to provide adjustable water treatment tank partitions and partitioning systems.

This application claims priority to U.S. provisional application number 63/782,375, which is entitled Treatment Tank Baffle System. The '375 application was filed on Apr. 2, 2025 and is incorporated by reference in its entirety herein.

### TECHNICAL FIELD

This application regards water treatment systems and more particularly water treatment systems, devices, and processes employing adjustable partition systems for use in treatment tank(s) of water treatment systems.

### BACKGROUND

Water, having various sources including septic wastewater, storm water, and process water (all of which may herein be collectively referred to as “water”) may be treated via a water treatment system comprising a treatment tank and one or more infiltration systems. In various applications, a water treatment system may receive water to be treated from a source and may pass that water through the system for treatment processing(es)and ultimately discharge that water to the environment via an infiltration field or other end of line discharge configuration.

Water treatment systems can vary in size and scope. They can be sized for treatment of large amounts of water from a municipality or other large cumulative system for benefitting many residences, businesses, and industrial facilities serviced by the municipality. Water treatment systems can be sized for smaller applications, such as single and multi-family residences, stand-alone retail commercial buildings, and other small-scale water treatment applications. For example, treatment tanks, and the water treatment systems they can be a part of, can be designed and sized for single-home residential use, and other small-scale residential and commercial uses.

In various applications, a water treatment system will often include an infiltration system with one or more infiltration fields. These infiltration fields often receive water from an upstream component, such as a treatment tank, and pass the water to surrounding soil via infiltration. The water is treated as it passes through the treatment tank, the infiltration field, applicable treatment media, and into the surrounding soil. A treatment tank may provide sedimentation or other treatment as water passes through it.

Treatment tanks may be formed in various shapes and sizes and can receive water directly from a source or from earlier upstream components of a water treatment system. The tank can provide temporary water storage, i.e. a buffering feature, to temporarily hold or slow the flow of water in the water treatment system. The tank, which may be designated as a vessel, receives water via an input and discharges water via an output. Common treatment tanks are constructed of concrete, have a rectangular shape, and have an access opening to provide servicing of the tank. Other configurations of treatment tanks, with different shapes and materials, are possible in embodiments.

### BRIEF DESCRIPTION OF THE DRAWINGS

FIG. 1A provides a front exploded view of a treatment tank partition with exemplary unattached perimeter sealing edges, as may be employed in some embodiments.

FIG. 1B provides a front view of the treatment tank partition from FIG. 1A with exemplary attached perimeter sealing edges, as may be employed in some embodiments.

FIG. 1C provides a side view of a treatment tank partition with connected exemplary perimeter sealing edge and connected exemplary elongated lateral stabilizers, as may be employed in some embodiments.

FIG. 1D provides a side view of a treatment tank partition with a stabilizer connector and a proximal end of a lateral stabilizer supported by the connector, as may be employed in some embodiments.

FIG. 2A shows a cross-sectional view of an adjustable perimeter sealing edge, as may be employed in some embodiments.

FIG. 2B shows a cross-sectional view of an adjustable perimeter sealing edge, as may be employed in some embodiments.

FIG. 2C shows cross-sectional views of elongated lateral stabilizers, with labelled widths and heights, as may be employed in some embodiments.

FIG. 3 shows a partial perspective view of a plurality of upright partitions, a plurality of elongated lateral stabilizers, various treatment media, and other components, all within a treatment tank, as may be employed in some embodiments.

FIG. 4 shows a partial perspective view of the partition system and treatment tank of FIG. 3, as may be employed in some embodiments.

FIG. 5 shows a partial perspective view of the partition system and treatment tank of FIG. 3 during assembly and prior to loading treatment media into the treatment tank, as may be employed in some embodiments.

FIG. 6 shows a partial perspective view of the partition system and treatment tank of FIG. 3, prior to loading treatment media into the treatment tank and with a loading cover, as may be employed in some embodiments.

FIG. 7 shows a partial perspective view of the partition system and treatment tank of FIG. 3 prior to loading treatment media into the treatment tank and with a loading cover, as may be employed in some embodiments.

FIG. 8 shows a partial perspective view of the partition system and treatment tank of FIG. 3 prior to loading treatment media into the treatment tank, as may be employed in some embodiments.

FIG. 9 shows a partial perspective view of the partition system and treatment tank of FIG. 3 while loading treatment media into a zone of the treatment tank, as may be employed in some embodiments.

FIG. 10 shows a partial perspective view of the partition system and treatment tank of FIG. 3, with the loading cover being clearly visible, while loading treatment media into a zone of the treatment tank, as may be employed in some embodiments.

FIG. 11 shows a partial perspective view of the partition system and treatment tank of FIG. 3 during assembly and after bio-ring treatment media has been placed in a zone of the treatment tank, as may be employed in some embodiments.

FIG. 12 shows a schematic cross-sectional view of an installed partition system wall where the tank walls are angled and not parallel and the partition wall is positioned in the perimeter sealing edges at different varying depths to accommodate the slanted tank walls, as may be employed in some embodiments.

### DETAILED DESCRIPTION

Embodiments are directed to partitions for treatment tanks and processes involving partitions for treatment tanks. In some embodiments, a treatment tank may serve as a component of a water treatment system and/or may be a self-contained water treatment system as well. Partitions, which may act baffles, may be located in the tank to define separate zones of the tank and thereby serve to provide sequential treatment zones within the tank. As wastewater moves from zone to zone in the tank, water treatment, via different mechanisms or the same mechanism, may be performed in the different sequential zones of the treatment tank. This treatment may comprise settlement or biological treatment or other treatment techniques and mechanisms.

In some embodiments, partitions may be employed to separate various zones in the treatment tank or other vessel of the water treatment system. The partition(s) may be self-supporting and may employ one or more adjustable perimeter sealing edges between themselves and the tank. Other alignment techniques, configurations, or processes, for setting up the partitions and for holding them in place in the tank may also be employed in some embodiments. In some embodiments, the partitions may be placed and then their respective tank zones may be filled with different media that serve to hold the partitions in place. Accordingly, some embodiments may employ elongated lateral stabilizers while some embodiments, which rely on treatment media or other techniques to stabilize the location of the upright partitions, may not employ elongated lateral stabilizers. These stabilizers may be secured or unsecured to both the partitions and the tank walls. The stabilizers may have connections that provide for compressive loads to be handled by the stabilizers. The stabilizers may have connections that provide for tensile loads to be handled by the stabilizers. In some embodiments, the partitions may use one or more expandable components, such as adjustable perimeter sealing edges, to press against internal walls or other components of the tank to partially or completely secure the partition or partitions in place. In some embodiments, elongated lateral stabilizers may be positioned to resist movement of partition(s) and/or hold them in place and/or apart from one another.

This disclosure provides systems, processes, apparatus, and articles of manufacture that may be configured, designed, manufactured, transported, installed or operated employing treatment tank partitions. In embodiments, the various features described herein may be combined in different ways and may be combined with or without additional components not specifically disclosed herein.

As noted above, treatment tank partitions of embodiments may employ one or more adjustable perimeter sealing edges. A perimeter sealing edge of embodiments may be moveable from a first retracted position to a second extended position, wherein, in the second extended position, the sealing edge meets and seals against an inner surface of a treatment tank. When sealed against an inner surface of a treatment tank, the sealing edge and partition to which the sealing edge is attached, may define a wall of an inner zone of the treatment tank. This inner zone of the treatment tank may be used for various purposes, which can include a settlement area, an aeration area, a storage buffering area, a treatment media area, and for other functional purposes as well. The partition itself may serve as a baffle or may solely serve as a partition. A baffle, is presently applied herein as a partition that is configured to manage movement of water passing by it, whereas a partition, as applied herein, is applied to mean a divider that may or may not serve as a baffle but is applied to be something that may only divide space. As used herein, all baffles are partitions but not all partitions are not necessarily baffles. Comparatively, the provisional application uses baffles when describing either baffles as noted above or partitions as noted above. Thus, in embodiments, a partition may or may not function as a baffle.

The adjustable perimeter sealing edge of a partition can promote quick division of a treatment tank into a plurality of zones using embodiments so configured. A partition with one or more perimeter sealing edges can be placed in a treatment tank and the one or more sealing edges can be extended towards and against an adjacent wall or other surface of a treatment tank so as to form a seal between the adjacent wall or other surface. In so doing, an upright partition may be readily placed and sealed against a treatment tank wall. This adjustability can provide for efficient installation of partitions in a treatment tank as the partitions can be sized to be smaller than its final placement location in the treatment tank and the difference in size between the final placement location of the treatment tank with any remaining space between the partition and the treatment tank to be bridged by one or more adjustable perimeter sealing edges. When sealing edges are placed in extended positions, friction may hold the partition and sealing edge in place. Other locking mechanisms may also be employed. For example, securing pins or threaded connectors may be employed to lock an extended sealing edge in place relative to an upright partition from which the sealing edge extends from. These locking mechanisms or other connectors may also be employed on tank walls to secure the lateral stabilizers in place.

During use, the partitions may be subjected to meaningful water loads or soil loads or media loads. For example, one zone of a partitioned treatment tank may contain water or a treatment media or both and an adjacent zone of the tank may contain less water or media or none at all. This difference in content may place meaningful loads against the partition separating the two adjacent zones. To oppose these loads, and help retain the partition in place within the treatment tank, the partition may be supported by one or more elongated lateral stabilizers. These elongated lateral stabilizers can have various shapes and sizes and may be supported by connectors on the partition, on a surface of the treatment tank or both. The connectors on the partition or the treatment tank may be sized and configured to allow for snug fitting of a connector to a supporting surface to be readily accomplished in the field. For example, one of the connectors may secure a distal or proximal end of an elongated lateral stabilizer and retard movement in all three axes while a connector on the other end of the elongated lateral stabilizer may only restrict movement along two axes, where the third axis, the y-direction, for example, may be less restricted so as to allow for easy connection of the elongated lateral stabilizer during installation. Gravity may then serve to hold this end of the elongated lateral stabilizer in place (from moving upward in the y-direction). In some embodiments, when the connector does not restrict in a certain direction, to promote installation or for another reason, another component may be added to the connector to retard movement in the upward y-direction or other direction after the installation of the elongated lateral stabilizer. Thus, in embodiments, connectors can provide support for both compressive and tensile loads between a lateral stabilizer and a wall (partition or tank) that the lateral stabilizer is connected to.

Partitions that are serving as a baffle may comprise perforations or slots or weirs or other techniques to manage water flowing from one section of the treatment tank to another section of the treatment tank. Water would also be able to move from one side of a partition to another via a pipe or conduit in the partition. For example, as an overflow conduit. As explained above, for purposes of the disclosure, a partition should be considered to encompass either a partition or a baffle as described herein, thus, a baffle is an exemplary subset of a type of partition.

The partitions, their sealing edges, and any stabilizing components may comprise various plastic, wood, metal, ceramic, foam, rubber, etc. materials in some embodiments. These materials may include PVC or other durable materials suitable for persistent interface with water. Piping and/or other columnar shapes, may be employed as one or more perimeter edges of a partition as well as one or more elongated lateral stabilizers. Plastic sheets or other plastic panels, fiberglass, and other suitable materials capable of long-term sustained interfacing with water and/or media may be employed as the upright walls of the partitions in some embodiments. The sheets or panels may be flat, wavy, cuspated, as well as other configurations and designs.

A partition support system that also supports or incorporates air diffusers or conglomerators into the partition support system may be included in embodiments. Accordingly, air conglomerators, and the like, may be employed in some embodiments. Air conglomerator sealing may be employed at or near the top of partitions of embodiments to prevent air from short circuiting around water column above the partition and the like, in some embodiments. In some embodiments, a radiused, smooth, round nosed bullet shaped cap may be positioned on end of air diffuser tubing in order to slide the diffuser past holes in a diffuser sleave.

In some embodiments, as noted above, partitions that are expandable or telescoping or have expandable ends/sides that may be employed to fit tightly in tanks of varying sizes to prevent short circuiting between adjacent treatment zones in the tank. This may make retrofitting into existing tanks simpler and may help with outfitting new tanks with undesirably large manufacturing tolerances.

In some embodiments, partition support systems, such as elongated lateral stabilizers, that reach one or more partitions, may provide structural support and/or resistive support to one or more partition. Such support systems and stabilizers, may take the loads from partition walls that contain different media. Certain support systems and stabilizers in embodiments may transfer loads to the tank walls to prevent the partitions from moving beyond certain deflection limits or ranges of distance.

In some embodiments partition support systems, such as elongated lateral stabilizers, may bear and transfer all live and static loads to exclusively the tank walls. In some embodiments partition support systems, such as elongated lateral stabilizers, may transfer a portion of the live and static loads to partitions and a portion of the live and static loads to the tank walls.

In some embodiments a modular partition arrangement that locates partitions in tanks without the need to pour in partition walls during the forming of a concrete or plastic treatment tank may be employed. In some embodiments, the need for placing fasteners into the treatment tank walls or having slots in the tank walls to accept partitions may be reduced or avoided altogether. In some embodiments, fasteners may be placed into the treatment tank walls or slots in the tank walls may be used to accept partitions and assist in securing them in place. In some embodiments, partitions may be retrofitted into treatment tanks that have not been originally constructed with partitions or to repair a treatment tank partition that has been degraded or damaged.

In some embodiments, partition systems may be used on new treatment tanks as well as on retrofitting of existing treatment tanks, to direct water flows and/or to partition media and treatment processes, within the treatment tank(s).

A system for retrofitting and constructing treatment tanks that allows components to be assembled outside of a treatment tank and lowered in, to complete the partition system installation, may be employed in some embodiments.

Partitions that do not require any fastening into tank structure or walls may be employed in some embodiments. In other words, partition systems may be self-supporting meaning partitions and partition systems may be employed where friction between the partition sealing edges and tank surfaces and friction between any lateral stabilizers or other stabilizers (or other partition system components) and tank surfaces may provide sufficient stability such that no fasteners (e.g., screws, glue, rivets, bolts, etc.) between the partition system and the tank walls may need to be employed in order to retain the partitions and partition systems in place with little to no effective movement once installed in a treatment tank. In some embodiments, tank surfaces may contain recesses or cutouts or other receiving areas to accept stabilizers or other partition system components. These recesses or cutouts or other receiving surfaces may be positioned and sized to accept or mate with lateral stabilizers or other partition system components in order to provide ease in assembly and/or resistance to partition system movement as a result of the additional opposing reactive forces from the tank that can be applied because of the recesses or cutouts or receiving areas of the tank surfaces.

Modular water treatment tank partition systems of embodiments may comprise a water treatment tank, a first upright partition, the first upright partition comprising a perimeter, the perimeter of the first upright partition comprising a first adjustable perimeter sealing edge, the first adjustable perimeter sealing edge adjustable from a first position to a second position; and a first elongated lateral stabilizer comprising a proximal end and a distal end, the proximal end supported by the first upright partition, the distal end extending away from the first upright partition and extending towards an internal surface of the water treatment tank or extending towards a second upright partition or extending towards a second elongated lateral stabilizer, wherein the first elongated lateral stabilizer is elongated meaning that the first lateral elongated lateral stabilizer has a length and a width, wherein the length is three or more times greater than the width, wherein the first lateral elongated stabilizer is positioned to receive reactive forces opposing movement of the first upright partition within the wastewater treatment tank from the water treatment tank or a component within the water treatment tank or both, wherein a majority of the perimeter of the first upright partition is within the wastewater treatment tank.

The modular water treatment tank partition systems may also comprise components within the water treatment tank which comprises the second upright partition or the second lateral stabilizer or both. In some embodiments, a modular water treatment tank partition system may comprise at least one adjustable perimeter sealing edge that is extendable from a first position to a second position. In some embodiments, the first upright partition may be a baffle, wherein the baffle may comprise one or more passages sized to permit water to pass through the first upright partition. In some embodiments, baffles may comprise a plurality of orifices, the plurality of orifices positioned along a width and a height of the first upright partition, which should be considered a baffle. In some embodiments, a first upright partition may comprise a second adjustable perimeter sealing edge, the second adjustable perimeter sealing edge adjustable from a first position to a second position.

In some embodiments, a first upright partition may have an exterior planar surface, the exterior planar surface comprising a connector in contact with the proximal end of the first lateral stabilizer. In some embodiments, a sealing edge may comprise a tubular member having a slit, the slit extending along the majority of a length of the tubular member, a portion of the first upright perimeter positioned in the slit of the tubular member. In some embodiments, a sealing edge may comprise a tubular member having a slit, the slit extending along the majority of a length of the tubular member, a majority of a perimeter side of the first upright perimeter positioned in the slit of the tubular member. In some embodiments, an adjustable perimeter sealing edge may be on all perimeter edges of an upright partition. This may include, for example, having four tubular members for a rectangular upright partition, with one tubular member or other type of adjustable sealing edge on each perimeter surface of the upright partition. In some embodiments, a second lateral stabilizer may comprise a proximal end and a distal end, the proximal end supported by the first upright partition, the distal end extending away from the first upright partition and towards a third upright partition or an internal surface of the wastewater treatment tank. In some embodiments, a second upright partition comprising a perimeter may be employed, the perimeter of the second upright partition comprising a first adjustable perimeter sealing edge, the first adjustable perimeter sealing edge adjustable from a first position to a second position. And, in some embodiments, a third lateral stabilizer may be employed, wherein the third lateral stabilizer comprises a proximal end and a distal end, the proximal end supported by a second upright partition, the distal end extending away from a second upright partition and towards another upright partition or an internal surface of the wastewater treatment tank.

In some embodiments, a modular water treatment tank partition system may be employed wherein the first lateral stabilizer has a lateral orientation and a cylindrical shape. In some embodiments, a modular water treatment tank partition system may be employed wherein the first lateral stabilizer has a cross-sectional profile of a circle, a polygon, an I-beam or a c-channel. In some embodiments, a modular water treatment tank partition system may be employed wherein the first adjustable perimeter sealing edge has a sealing material applied to a side touching the treatment tank. In some embodiments, a modular water treatment tank partition system may be employed wherein the first adjustable perimeter sealing edge is a c-channel, flat strip or other shape. In some embodiments, a modular water treatment tank partition system may be employed wherein the width of an elongated lateral stabilizer is an outside diameter. In some embodiments, a modular water treatment tank partition system may be employed wherein a sealing edge comprises a pipe having a slit, the slit extending along the majority of a length of the pipe, a portion of the first upright perimeter positioned in the slit of the pipe. In some embodiments, a modular water treatment tank partition system may be employed wherein the first lateral elongated stabilizer may be positioned to receive reactive forces opposing movement of the first upright partition within the wastewater treatment tank from the water treatment tank or a component within the water treatment tank or both wherein the component may be an upright partition or an elongated lateral stabilizer.

A process of partitioning a water treatment tank may also be employed in embodiments. This process may comprise providing a first upright partition, the first upright partition comprising a perimeter, the perimeter of the first upright partition comprising a first adjustable perimeter sealing edge, the first adjustable perimeter sealing edge adjustable from a first position to a second position; providing a first elongated lateral stabilizer comprising a proximal end and a distal end, the proximal end supported by the first upright partition, the distal end extending away from the first upright partition and extending towards an internal surface of the water treatment tank or extending towards a second upright partition or extending towards a second elongated lateral stabilizer; and placing the first upright partition into a water treatment tank, wherein the first elongated lateral stabilizer is elongated meaning that the first lateral elongated lateral stabilizer has a length and a width, wherein the length is three or more times greater than the width, wherein the first lateral elongated stabilizer is positioned to receive reactive forces opposing movement of the first upright partition within the wastewater treatment tank from the water treatment tank or a component within the water treatment tank or both, wherein a majority of the perimeter of the first upright partition is within the wastewater treatment tank.

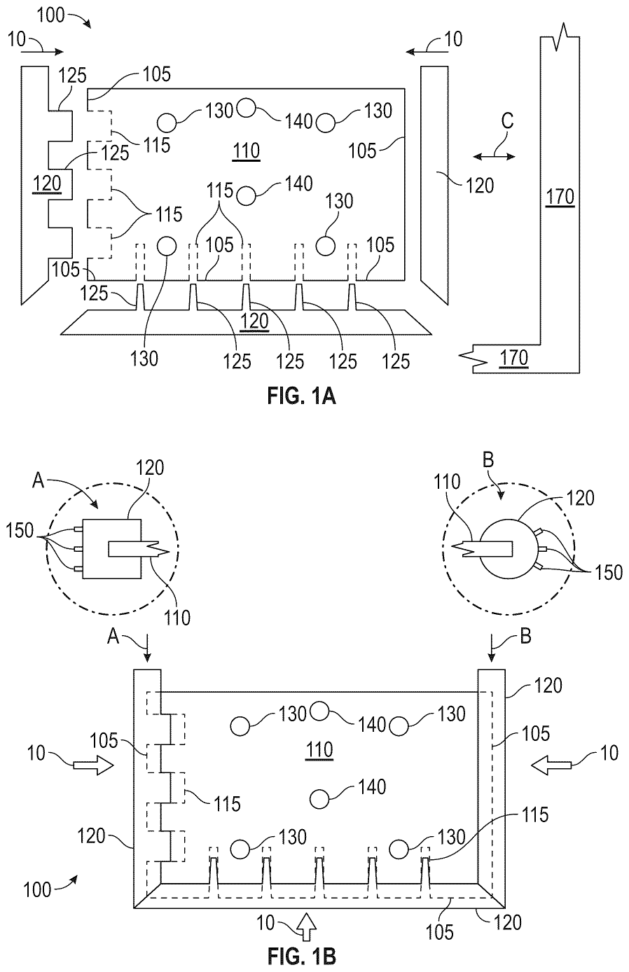

FIG. 1A provides a front exploded view of a treatment tank partition with exemplary unattached perimeter sealing edges, as may be employed in some embodiments. A modular water treatment tank partition system 100 is shown with tank walls 170, adjustable perimeter sealing edges 120, upright partition 110, edges 105 of partition 110, connectors 130, passages 140, arrows 10 showing the direction in which the sealing edges 120 may move when attaching to the partition 110. Receiving recesses 115 are also shown in the partition 110. These recesses 115 are shown to mate with corresponding protrusions 125 of the sealing edges 120. These protrusions 125 and recesses 115 may be on either the partition or the sealing edges and may serve to provide alignment during assembly as well as when the sealing edges are moved from a retracted position to a more extended position in order to seal against the wall 170 of a tank. As can be seen in FIG. 1 sealing edges 120 and edges 105 of the partition 110 need not have these mating recesses 115 and protrusions 125 in some instances.

FIG. 1B provides a front view of the treatment tank partition from FIG. 1A with exemplary attached perimeter sealing edges, as may be employed in some embodiments. The labelling from FIG. 1A applies here and in the other Figures as well. As can be seen in FIG. 1B, the protrusions 125 can sit inside of the recesses 115 when the sealing edges are close by the partition and in an installed or ready for installation assembled configuration. Arrows 10 show how the sealing edges 120 can be moved inward towards the edges 105 of the partition to place them in an installed or ready for installation assembled configuration. View A shows a top-down view of the sealing edge 120 and partition 110. As can be seen in View A the sealing edge 120 is in the shape of a polygon and has compressible sealing nubs 150 on the outer surface that can interface with the inside of wall 170 of FIG. 1A. View B shows a top-down view of the sealing edge 120 and partition 110. As can be seen in View B the sealing edge 120 is in the shape of a circle and has compressible sealing nubs 150 on the outer surface that can interface with the inside of wall 170 of FIG. 1A. As noted above, the sealing edge can have various configurations including the shown polygon and circle. Other shapes can include ovals, non-symmetrical shapes, smooth perimeter shapes, jagged perimeter shapes, etc. Likewise, the nubs 150 can have various shapes. In embodiments, these nubs may be compressible and made from materials with high friction coefficients such that when the sealing edge is in contact with a tank wall a tight seal may exist. This tight seal may, in some embodiments, retard or prevent the passage of water and may, in some embodiments, provide some frictional resistance to the movement of the partition relative to the tank wall.

FIG. 1C provides a side view of a treatment tank partition with connected exemplary perimeter sealing edge and connected exemplary elongated lateral stabilizers, as may be employed in some embodiments. The elongated lateral stabilizers 160 and shown with their ends connected to connectors 130 of the partition 110. The sealing edge 120 in this view shows that in embodiments the sealing edge may be wider than the edge of the partition 120. However, in some embodiments the sealing edge may be the same thickness as the partition and may be narrower than the thickness of the sealing edge as well.

FIG. 1D provides a side view of a treatment tank partition with a stabilizer connector 130 and a proximal end of a lateral stabilizer 160 supported by the connector 130, as may be employed in some embodiments. The connector 130 in FIG. 1D is shown with an open top area such that the proximal end of the lateral stabilizer may simply drop into the connector during assembly. Once installed, a cover may be placed over the top of the lateral stabilizer in the area shown by arrow 170. This cover, which is not shown, may retard upwards movement of the proximal end of the lateral stabilizer.

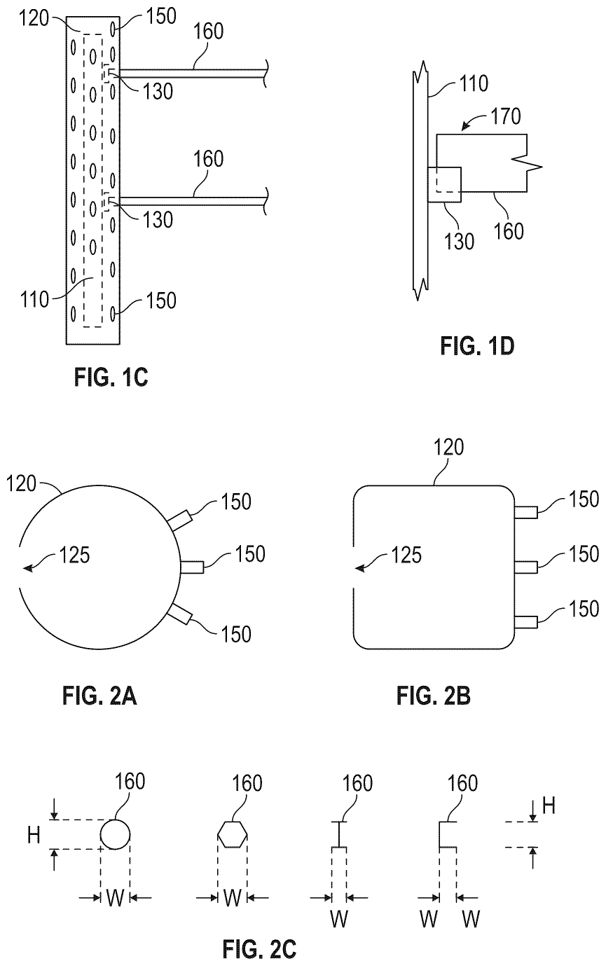

FIG. 2A shows a cross-sectional view of an adjustable perimeter sealing edge, as may be employed in some embodiments and FIG. 2B shows a cross-sectional view of an adjustable perimeter sealing edge, as may be employed in some embodiments. The sealing edge 120 in FIG. 2A is shown to be round while the sealing edge 120 in FIG. 2B is shown to be a polygon with rounded corners. As mentioned above, the sealing edges may have various configurations. The slit 125, is shown in both FIGS. 2A and 2B and can be sized to accept the perimeter edge of the partition with some frictional grab to aid in securement between the sealing edge 120 and the partition 110, which are labelled and shown in other Figures. The nubs 150 are shown in both FIGS. 2A and 2B.

FIG. 2C shows cross-sectional views of elongated lateral stabilizers 160, with labelled widths and heights, as may be employed in some embodiments. If an elongated stabilizer is not uniform in height or width the average of the height or width along its length should be when determining if the claimed ratios are met for purposes of determining if a component is considered to be elongated.

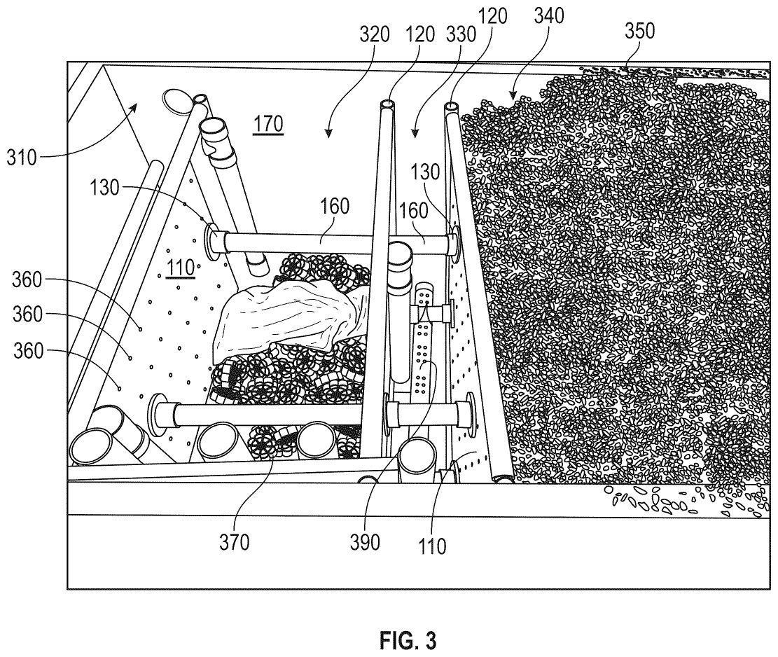

FIGS. 3-11 show various views of a modular partition system in a treatment tank during installation. The views vary in what is seen and should be understood to be viewing the same tank and modular partition system, but just from varied partial views.

FIG. 3 shows a partial perspective view of a plurality of upright partitions, a plurality of elongated lateral stabilizers, various treatment media, and other components, all within a treatment tank, as may be employed in some embodiments. Treatment zones 310, 320, 330, and 340 are labelled in FIG. 3. Also labelled is partition 110, which is shown with plurality of passages 360, which mean the partition 110 should be considered to be a baffle. Treatment media 350 is shown in zone 340 which zones 310, 320 and 330 are shown to be empty. During use, each of these zones may have water in them, with different standing surface levels depending upon where the entry and discharge ports are for each zone. Bubbler 390 is shown in Zone 330 and bio-rings 370 are shown in zone 320. Lateral stabilizers 160 are visible in zones 320 and 330.

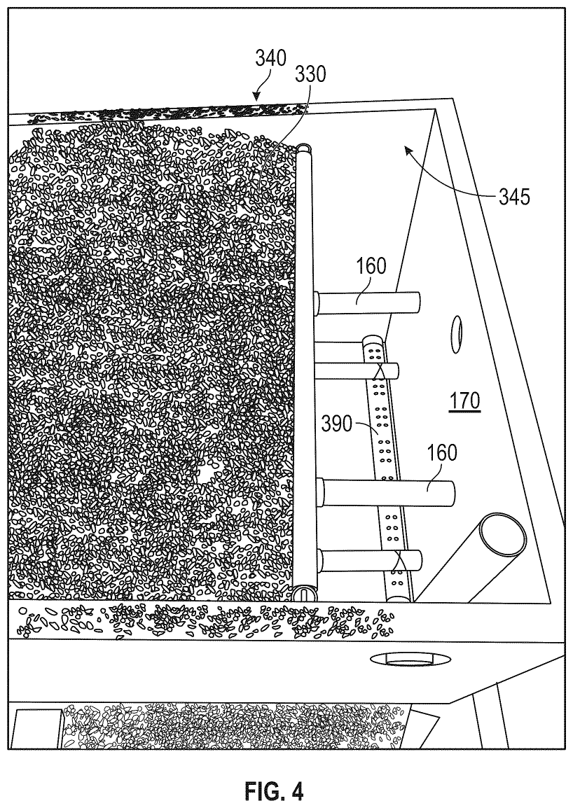

FIG. 4 shows a partial perspective view of the partition system and treatment tank of FIG. 3, as may be employed in some embodiments. An end of the tank with zones 340 and 345 being visible is shown in FIG. 4. The treatment media 350 is shown placed into zone 340 while zone 345 is shown to be missing treatment media or having an insignificant amount. Treatment media may be kept from zone 345 during assembly by placing a temporary filling cover over zone 345 while zone 340 is being filled with treatment media. Once the media is deposited the temporary filling cover may be removed. Aerator 390 is shown near the bottom of zone 345.

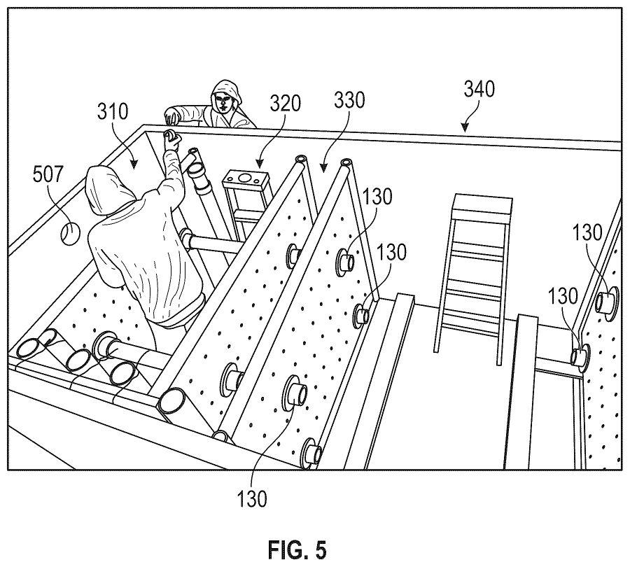

FIG. 5 shows a partial perspective view of the partition system and treatment tank of FIG. 3 during assembly and prior to loading treatment media into the treatment tank, as may be employed in some embodiments. Zones 310, 320, 330, and 340 are labelled in FIG. 5. Connectors 130 are not shown with any lateral stabilizers in zone 340. This zone 340 is targeted to have the treatment media, which may be relied upon to provide lateral support in some embodiments, so here, as in other embodiments, lateral stabilizers may not be employed in each zone. Lateral stabilizers can be seen in zones 320 and 330 of FIG. 5. Tank entrance port 507 is visible and labelled in FIG. 5.

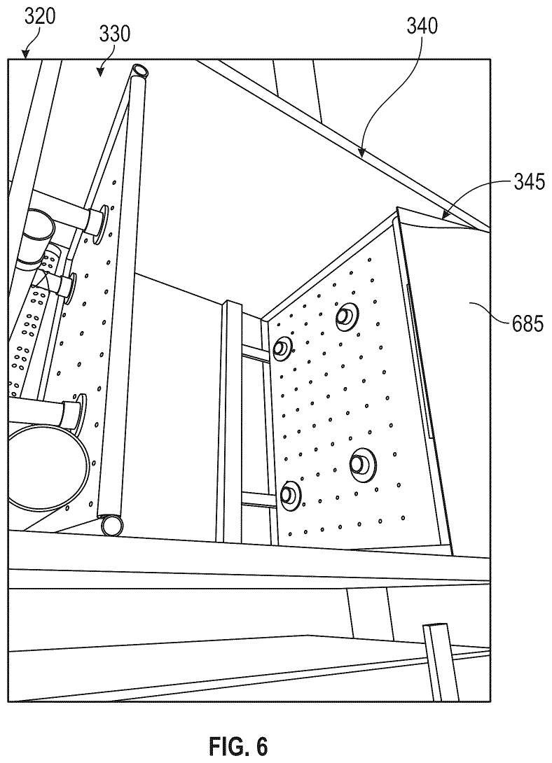

FIG. 6 shows a partial perspective view of the partition system and treatment tank of FIG. 3, prior to loading treatment media into the treatment tank and with a loading cover, as may be employed in some embodiments. Zone 340 is shown prior to loading treatment media. A cover 685 is shown over zone 345. The cover may also be placed over other zones depending upon where the treatment media will be dumped from. For example, of loading is done from the right in FIG. 6 then placing a cover 685 over zone 345 is suitable. Comparatively, if loading is done from the left, placing a cover over zones 310, 32, and 330 would be more suitable.

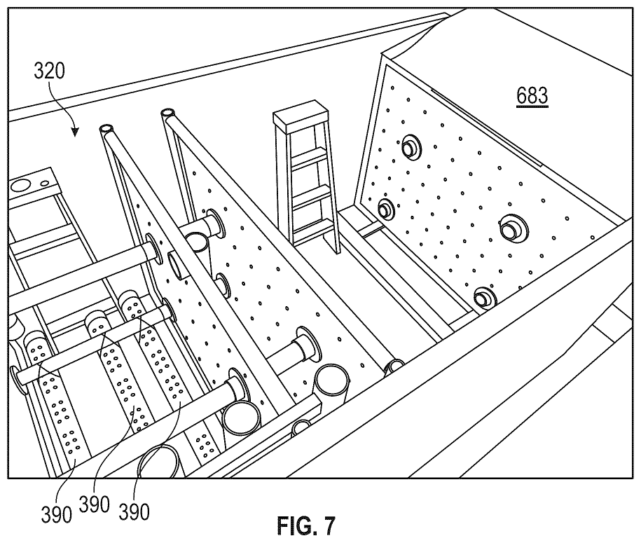

FIG. 7 shows a partial perspective view of the partition system and treatment tank of FIG. 3 prior to loading treatment media into the treatment tank and with a loading cover 685, as may be employed in some embodiments. Bubbler 390 pipes are visible in zone 320 of FIG. 7. Bio-rings or other treatment media may be placed in this or other zones in embodiments. Visible in FIG. 7, a top-down view of a tank with a several partition walls creating multiples zones where one of the zones contains wood chips and another of the zones contains a different carbon source, are PVC support pipes along with PVC vertical pipes. The vertical pipes and bubbler pipes 390 are air diffuser sleaves to enhance air diffusers and allow cleaning and replacement. In embodiments, the diffusers and bubbler piping may be directly connected to a blower or used to house an air diffuser and may be used to introduce air into water present in any zone with bubbler piping.

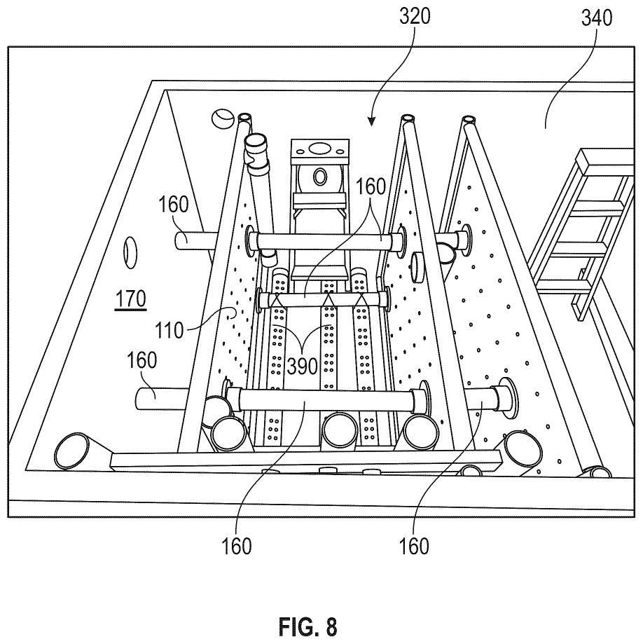

FIG. 8 shows a partial perspective view of the partition system and treatment tank of FIG. 3 prior to loading treatment media into the treatment tank, as may be employed in some embodiments. Bubbler piping 3960 is shown at the bottom of zone 320. As can be seen, the lateral stabilizers may also be used to support bubbler piping 390. In FIG. 8, cross straps are employed to secure the bubbler piping to lateral stabilizers. Also visible in FIG. 8 is that the lateral stabilizers 160 interfacing with the tank wall 170 do not have a connector to rest on. Rather, sizing of the lateral stabilizers and the connection end to the partition wall work to provide sufficient support for the lateral stabilizer to remain in place with little movement. In these attachment topologies, the lateral stabilizers are resisting compressive loads but provide little if any resistance to tensile loads. Thus, the first partition 110 is retarded form movement towards the near tank wall parallel to it via these lateral stabilizers. Movement in the opposite direction is retarded via lateral stabilizers in zone 320 as they offer resistance in compression loading. Media placed in zone 340 can resist movement of partitions. In some embodiments, lateral stabilizers may also be installed in zones where media is expected to also be placed. Also visible in FIG. 8 are the numerous passages present in the partition walls. As these passages are present, the partitions may be designed as baffles as explained above.

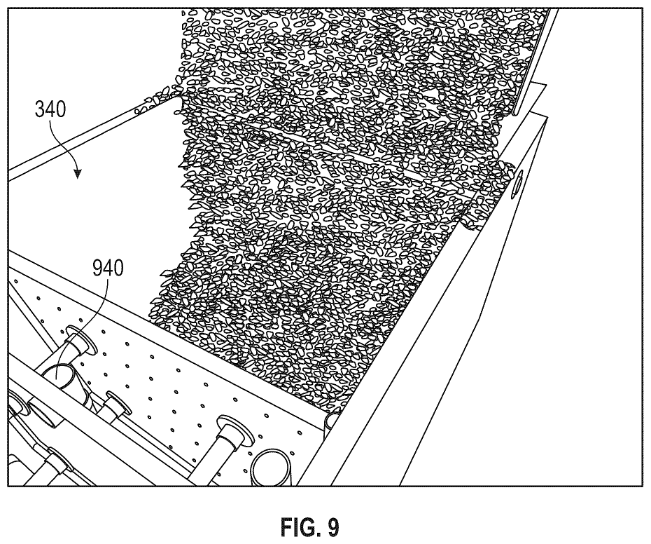

FIG. 9 shows a partial perspective view of the partition system and treatment tank of FIG. 3 while loading treatment media into zone 340 of the treatment tank, as may be employed in some embodiments. A T coupling 940 is labelled in FIG. 9. This T coupling acts as an overflow passage between zones should the water flow through the baffle partition be insufficient to keep up with intake flow.

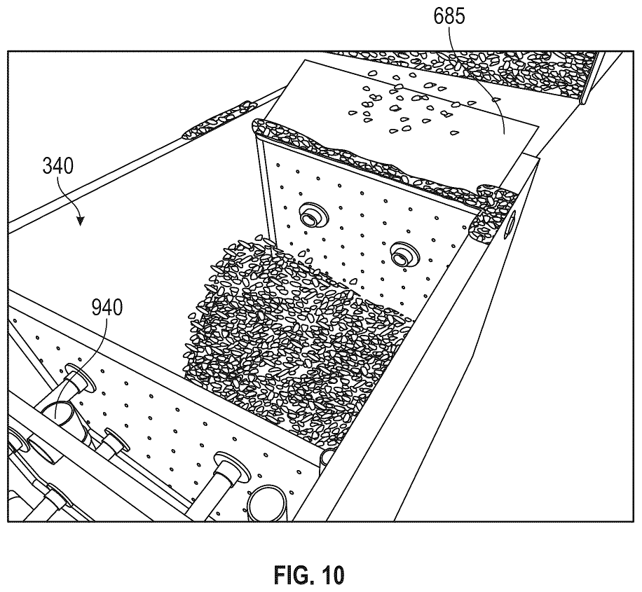

FIG. 10 shows a partial perspective view of the partition system and treatment tank of FIG. 3, with the loading cover 685 being clearly visible, while loading treatment media into zone 340 of the treatment tank, as may be employed in some embodiments.

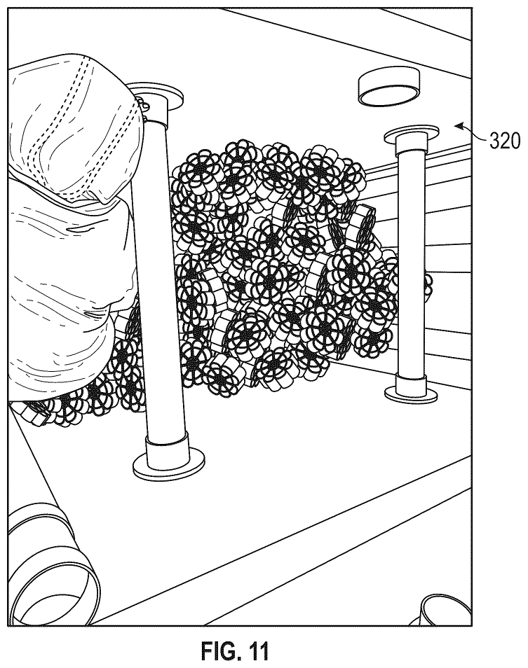

FIG. 11 shows a partial perspective view of the partition system and treatment tank of FIG. 3 during assembly and after bio-ring treatment media has been placed in zone 320 of the treatment tank, as may be employed in some embodiments. Treatment media can occupy some, most or all of a zone in embodiments. As can be seen in FIG. 11, the bio-rings occupy some of zone 320. The passages in the baffle partition walls are not shown for ease of illustration. The passages are shown in other Figures.

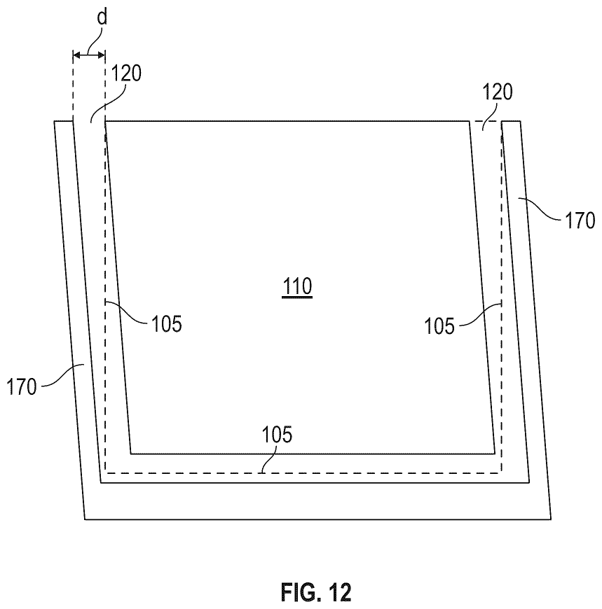

FIG. 12 shows a schematic cross-sectional view of an installed partition system wall 110 where the tank walls 170 are angled and not parallel to each other and the edges 105 of the partition wall 110 are inserted into the perimeter sealing edges 120 at different varying depths to accommodate the slanted tank walls, as may be employed in some embodiments. This ability to accommodate imperfect tank walls may provide for quicker installations and for better sealing between the sealing edges and the tank walls in some embodiments.

The various figures show different zones separated by two partitions and the tight-fitting nature of each partition against the internal tank walls. Step ladders are visible in some figures and provide some scale as to the proportions of these partition and tank components. Some Figures show that partition walls need not be equally spaced between each other within the tank and the lateral stabilizers may be present in zones anticipated to be filled with water and may be absent from zones expected to be filled with wood chips or other treatment media.

Embodiments may comprise manufacturing, assembling, installing, transporting, and processes using the various devices taught herein. This may include manufacturing, assembling, installing, transporting, and using portions of various features as taught herein. Residential wastewater systems may operate using features of the disclosure taught herein. Variations may also be employed in manufacturing, assembling, installing, transporting, and processes as well as in other embodiments. Likewise, the various teachings provided herein may be combined in different ways than those explicitly described. Features may be mixed and matched between various embodiments as well.

An infiltration surface as used herein should be understood to be a surface through which water can enter the ground. Some examples include: where water infiltrates into bare soil in a field or garden; surfaces where water can pass through and infiltrate into treatment media of a partially or fully buried infiltration component or infiltration system or infiltration field; where water infiltrates into vegetated areas such as lawns, forests or rain gardens, or other surfaces where water can pass through and infiltrate into a media. In embodiments, infiltration surfaces may be present on various surfaces of an infiltration field of an infiltration system. These infiltration surfaces may comprise infiltration openings (e.g., slots, slits, circular orifices, penetrations, holes, passages, etc.) to permit the infiltration of water to receiving media.

The preceding detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” or equivalents do not necessarily refer to the same embodiment. Particular features, structures, or characteristics may be combined in any suitable manner consistent with this disclosure.

While some embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention.

For example, some embodiments may comprise using the processes, systems, articles of manufacture, or apparatus with or in wastewater systems that serve single residences, multi-family residences, commercial businesses, public organizations/property, private organizations/property, government buildings, and any other situation where onsite wastewater treatment or storm water management is used. Some embodiments may comprise using the processes, systems, articles of manufacture, or apparatus with or in community based onsite wastewater treatment systems and any soil or water-based treatment systems serving as intermediate or final treatment or dispersal for wastewater treatment plants. Some embodiments may comprise using the processes, systems, articles of manufacture, or apparatus with or in systems that employ a geotextile fabric within and/or around the system. The geotextile fabric may stabilize the sediment during treatment to avoid soil stratification by particle size.

The terminology used herein is for the purpose of describing particular embodiments only and is not intended to be limiting of the invention. As used herein, the singular forms “a,” “an” and “the” are intended to include plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “about” or “approximately” in reference to a recited numeric value, including for example, whole numbers, fractions, and/or percentages, generally indicates that the recited numeric value encompasses a range of numerical values (e.g., +/−5 % to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of any ranges of values herein are merely intended to serve as a shorthand method of referring individually to each separate value falling within the range, unless otherwise indicated herein, and each separate value is incorporated into the specification as if it were individually recited herein.

“First,” “Second,” etc. As used herein, these terms are used as labels for nouns that they precede, and do not imply any type of ordering (e.g., spatial, temporal, logical, etc.). For example, reference to a “first” item does not necessarily imply that this item is the item in a sequence; instead, the term “first” is used to differentiate this item from another item (e.g., a “second” item).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The corresponding structures, material, acts, and equivalents of any means or steps plus function elements in the claims are intended to include any structure, material or act for performing the function in combination with other claimed elements. The description of certain embodiments of the present invention has been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A modular water treatment tank partition system comprising:
a water treatment tank;
a first upright partition, the first upright partition comprising a perimeter, the perimeter of the first upright partition comprising a first adjustable perimeter sealing edge, the first adjustable perimeter sealing edge adjustable from a first position to a second position; and
a first elongated lateral stabilizer comprising a proximal end and a distal end, the proximal end supported by the first upright partition, the distal end extending away from the first upright partition and extending towards an internal surface of the water treatment tank or extending towards a second upright partition or extending towards a second elongated lateral stabilizer,
wherein the first elongated lateral stabilizer is elongated meaning that the first lateral elongated lateral stabilizer has a length and a width, wherein the length is three or more times greater than the width,
wherein the first lateral elongated stabilizer is positioned to receive reactive forces opposing movement of the first upright partition within the wastewater treatment tank from the water treatment tank or a component within the water treatment tank or both,
wherein a majority of the perimeter of the first upright partition is within the wastewater treatment tank.

2. The modular water treatment tank partition system of claim 1 wherein the component within the water treatment tank comprises the second upright partition or the second lateral stabilizer or both.

3. The modular water treatment tank partition system of claim 1 wherein at least one of the adjustable perimeter sealing edges is extendable from a first position to a second position.

4. The modular water treatment tank partition system of claim 1 wherein the first upright partition is a baffle, the baffle comprising one or more passages sized to permit water to pass through the first upright partition.

5. The modular water treatment tank partition system of claim 1 wherein the first upright partition is a baffle, the baffle comprising a plurality of orifices, the plurality of orifices positioned along a width and a height of the first upright partition.

6. The modular water treatment tank partition system of claim 1 wherein the first upright partition comprises a second adjustable perimeter sealing edge, the second adjustable perimeter sealing edge adjustable from a first position to a second position.

7. The modular water treatment tank partition system of claim 1 wherein the first upright partition has an exterior planar surface, the exterior planar surface comprising a connector in contact with the proximal end of the first lateral stabilizer.

8. The modular water treatment tank partition system of claim 1 wherein the sealing edge comprises a tubular member having a slit, the slit extending along the majority of a length of the tubular member, a portion of the first upright perimeter positioned in the slit of the tubular member.

9. The modular water treatment tank partition system of claim 1 wherein the sealing edge comprises a tubular member having a slit, the slit extending along the majority of a length of the tubular member, a majority of a perimeter side of the first upright perimeter positioned in the slit of the tubular member.

10. The modular water treatment tank partition system of claim 1 wherein the second lateral stabilizer comprises a proximal end and a distal end, the proximal end supported by the first upright partition, the distal end extending away from the first upright partition and towards a third upright partition or an internal surface of the wastewater treatment tank

11. The modular water treatment tank partition system of claim 8 wherein the second upright partition comprises a perimeter, the perimeter of the second upright partition comprising a first adjustable perimeter sealing edge, the first adjustable perimeter sealing edge adjustable from a first position to a second position; and
a third lateral stabilizer comprising a proximal end and a distal end, the proximal end supported by the second upright partition, the distal end extending away from the second upright partition and towards another upright partition or an internal surface of the wastewater treatment tank.

12. The modular water treatment tank partition system of claim 1 wherein the first lateral stabilizer has a lateral orientation and a cylindrical shape.

13. The modular water treatment tank partition system of claim 1 wherein the first lateral stabilizer has a cross-sectional profile of a circle, a polygon, an i-beam or a c-channel.

14. The modular water treatment tank partition system of claim 1 wherein the first adjustable perimeter sealing edge has a sealing material applied to a side touching the treatment tank.

15. The modular water treatment tank partition system of claim 1 wherein the first adjustable perimeter sealing edge is a c-channel, flat strip or other shape.

16. The modular water treatment tank partition system of claim 1 wherein the width is an outside diameter.

17. The modular water treatment tank partition system of claim 1 wherein the sealing edge comprises a pipe having a slit, the slit extending along the majority of a length of the pipe, a portion of the first upright perimeter positioned in the slit of the pipe.

18. The modular water treatment tank partition system of claim 1 wherein the first lateral elongated stabilizer is positioned to receive reactive forces opposing movement of the first upright partition within the wastewater treatment tank from the water treatment tank or a component within the water treatment tank or both wherein the component is an upright partition or an elongated lateral stabilizer.

19. The modular water treatment tank partition system of claim 1 wherein the first lateral elongated stabilizer is positioned to support an air diffuser conduit sleave, the air diffuser tubing having a bullet shaped end sized to slide past one or more orifices in the air diffuser conduit sleave.

20. A process of partitioning a water treatment tank, the process comprising:
providing a first upright partition, the first upright partition comprising a perimeter, the perimeter of the first upright partition comprising a first adjustable perimeter sealing edge, the first adjustable perimeter sealing edge adjustable from a first position to a second position;
providing a first elongated lateral stabilizer comprising a proximal end and a distal end, the proximal end supported by the first upright partition, the distal end extending away from the first upright partition and extending towards an internal surface of the water treatment tank or extending towards a second upright partition or extending towards a second elongated lateral stabilizer; and
placing the first upright partition into a water treatment tank,
wherein the first elongated lateral stabilizer is elongated meaning that the first lateral elongated lateral stabilizer has a length and a width, wherein the length is three or more times greater than the width,
wherein the first lateral elongated stabilizer is positioned to receive reactive forces opposing movement of the first upright partition within the wastewater treatment tank from the water treatment tank or a component within the water treatment tank or both,
wherein a majority of the perimeter of the first upright partition is within the wastewater treatment tank.
